(19) United States
(12) Patent Application Publication
(10) Pub. No.: US 2026/0202201 A1
(43) Pub. Date: Jul. 16, 2026

(54) Gyroscope Data Conversion Method for Smart Wearable Devices

(71) Applicant: HOOROO NETWORK PTE. LTD., SINGAPORE (SG)

(72) Inventors: Yuan Yao, Shenzhen (CN); Chao Guo, Shangrao (CN)

(21) Appl. No.: 19/026,065

(22) Filed: Jan. 16, 2025

(51) Int. Cl. G01C 19/5776

(52) U.S. Cl. CPC G01C 19/5776

(57) ABSTRACT

A gyroscope data conversion method for smart wearable devices includes the following steps. Firstly, a gyroscope data accuracy evaluation index is obtained from the gyroscope data acquired within a preset time period, and based on this index, a determination is made regarding whether to perform data preprocessing. The gyroscope data accuracy evaluation index is used to quantify the accuracy of the gyroscope data. If data preprocessing is required, a gyroscope processing accuracy evaluation index is derived from the gyroscope processing data after preprocessing and the gyroscope data accuracy evaluation index, and it is determined whether to perform data preprocessing optimization based on this new index. The gyroscope processing accuracy evaluation index is used to quantify the accuracy of the preprocessed gyroscope data. This method effectively enhances the universality of smart wearable devices and improves the accuracy of gyroscope data conversion, thereby addressing the problem of inaccurate gyroscope data conversion.

### TECHNICAL FIELD

The present invention relates to the technical field of digital data processing, and in particular, to a gyroscope data conversion method for smart wearable devices.

### BACKGROUND

With the development of smart wearable devices, the direction key instruction conversion method based on three-dimensional motion data is widely used in fields such as game control, virtual reality interaction, and health monitoring. By using sensors such as accelerometers and gyroscopes to collect user motion data in real time and analyzing it with algorithms, this technology realizes the seamless connection between natural motions and digital instructions, significantly improving the convenience and immersion of human-computer interaction. However, it still faces many challenges in terms of algorithm robustness, hardware performance, and user experience, promoting continuous exploration in the direction of multimodal fusion and personalized optimization.

The existing direction key instruction conversion technology for smart wearable devices mainly relies on sensors such as accelerometers, gyroscopes, and magnetometers. After collecting three-dimensional motion data, it analyzes user motions through signal processing and motion recognition algorithms and maps them into direction key instructions such as up, down, left, and right. Common methods include rule-based threshold judgment, machine learning classification, and deep learning models. Some devices support real-time calibration and adaptive optimization to improve accuracy and response speed. However, the universality problem of smart wearable devices and the inconsistent data of gyroscope chips from different manufacturers affect the practical application effect.

For example, the patent application with publication number CN115766819A discloses a gyroscope data transmission method, device, medium, and equipment for cloud games, including: receiving control data of a cloud game sent by a user terminal, where the user terminal supports a gyroscope; determining whether the control data is gyroscope data; if the control data is gyroscope data, parsing the control data to obtain control data adapted to the cloud game; storing the control data adapted to the cloud game in a data buffer area and sending a data trigger message to the cloud game, so that the cloud game obtains the control data adapted to the cloud game from the data buffer area. After determining that the received control data is gyroscope data, the gyroscope data is stored in the data buffer area and the cloud game is notified.

For example, the invention patent with publication number CN112762918B discloses an integrated digital angular velocity gyroscope, a prediction filtering method, and an electronic device, including an angular velocity gyroscope, a DSP microcontroller, and a serial port interface connected in sequence. The DSP microcontroller includes a prediction filtering module, and the prediction filtering module processes the angular velocity signal transmitted by the angular velocity gyroscope and outputs a prediction filtering signal from the serial port interface.

However, in the process of implementing the technical solution of the embodiments of the present application, it is found that the above-mentioned technologies have at least the following technical problems:

In the prior art, the inconsistent chip models of different manufacturers lead to inconsistent gyroscope data and accelerometer data, resulting in the lag of gyroscope data conversion and the problem of inaccurate gyroscope data conversion during user motion recognition through smart wearable devices.

### SUMMARY

The embodiments of the present application solve the problem of inaccurate gyroscope data conversion during user motion recognition through smart wearable devices in the prior art by providing a gyroscope data conversion method for smart wearable devices, and achieve the improvement of the accuracy of gyroscope data conversion.

The embodiments of the present application provide a gyroscope data conversion method for smart wearable devices, including the following steps: obtaining a gyroscope data accuracy evaluation index from the gyroscope data acquired in a preset time period, and determining whether to perform data preprocessing according to the gyroscope data accuracy evaluation index. The gyroscope data accuracy evaluation index is used to quantify the accuracy of the gyroscope data. If data preprocessing is performed, a gyroscope processing accuracy evaluation index is obtained based on the gyroscope processing data after data preprocessing and the gyroscope data accuracy evaluation index, and it is determined whether to perform data preprocessing optimization according to the gyroscope processing accuracy evaluation index. The gyroscope processing accuracy evaluation index is used to quantify the accuracy of the gyroscope data after data preprocessing. Dynamic data mapping is performed based on the gyroscope processing data, and a dynamic mapping accuracy index is obtained by combining the acquired motion feedback data with the gyroscope processing accuracy evaluation index, and it is determined whether to perform mapping optimization according to the dynamic mapping accuracy index. The dynamic mapping accuracy index is used to judge the accuracy of the dynamic data mapping.

Further, the gyroscope data includes the angular velocities of the three axes of the gyroscope, a timestamp, a sampling frequency, a zero-bias drift, a noise density, a response rate, and a temperature drift rate. The angular velocities of the three axes of the gyroscope include the angular velocity of the X-axis, the angular velocity of the Y-axis, and the angular velocity of the Z-axis. The angular velocities of the three axes of the gyroscope and the response rate are the mean values of the corresponding data in the preset time period. The gyroscope processing data includes the zero-bias mean, the angular velocity variance, the noise variance, the vector consistency error, the time integration error, and the sensitivity error. The motion feedback data includes the motion recognition accuracy rate, the missed recognition rate, the false recognition rate, the motion recognition delay, the instruction conversion delay, and the false triggering rate.

Further, the specific process of obtaining the gyroscope data accuracy evaluation index is as follows: numbering the preset time periods and obtaining reference gyroscope data from a preset database. The reference gyroscope data includes the expected angular velocity values, the set timestamp, and the set sampling frequency. The expected angular velocity values include the expected angular velocity of the X-axis, the expected angular velocity of the Y-axis, and the expected angular velocity of the Z-axis. The angular velocity accuracy coefficient is obtained according to the angular velocities of the three axes of the gyroscope and the expected angular velocity values. The angular velocity accuracy coefficient is used to quantify the accuracy of the angular velocity of the gyroscope in the smart wearable device. Data preprocessing is performed on the zero-bias drift, the noise density, the response rate, and the temperature drift rate. The data preprocessing is used to remove the units and unify the dimensions of the data. The gyroscope data accuracy evaluation index is obtained by processing the results after data preprocessing in combination with the angular velocity accuracy coefficient and the corresponding reference gyroscope data.

Further, the specific process of determining whether to perform data preprocessing according to the gyroscope data accuracy evaluation index is as follows: obtaining the collection adjustment threshold from the preset database and comparing it with the gyroscope data accuracy evaluation index. If the gyroscope data accuracy evaluation index is not less than the collection adjustment threshold obtained from the preset database, data preprocessing is performed. If the gyroscope data accuracy evaluation index is less than the collection adjustment threshold obtained from the preset database, the collection frequency is increased according to the preset adjustment ratio and the standby wireless network is switched to.

Further, the specific steps of performing data preprocessing are as follows: Step 1, performing time series synchronization on the gyroscope data and performing interpolation processing according to the preset sampling rate. The interpolation processing is used to ensure the integrity of the gyroscope data. Step 2, performing noise removal processing on the gyroscope data through a low-pass filtering program. The noise removal processing is used to eliminate the random fluctuations from equipment vibration, electromagnetic interference, and the measurement environment. Step 3, performing standardization processing on the gyroscope data. The standardization processing means that the gyroscope data conforms to the change trend of a standard normal distribution with a mean of 0 and a standard deviation of 1.

Further, the specific process of obtaining the gyroscope processing accuracy evaluation index is as follows: substituting the gyroscope data after data preprocessing into the specific limit expression of the gyroscope data accuracy evaluation index to obtain the optimized gyroscope data accuracy evaluation index. Normalizing the gyroscope processing data. The normalization processing is used to ensure that the gyroscope optimized data is in the same dimension. The gyroscope processing accuracy evaluation index is obtained based on the gyroscope data accuracy evaluation index, the optimized gyroscope data accuracy evaluation index, and the normalized gyroscope processing data.

Further, the specific method of obtaining the gyroscope processing accuracy evaluation index is as follows:

$${GPA}_{t} = [ {( \frac{e - 1}{e + 1} )}^{l n ( Z {M}_{t} + A {V}_{t} + N {V}_{t} + V {C}_{t} + T {I}_{t} + S {E}_{t} + 1 )} + 1 ] * cosh ( \frac{{GPA}_{{t}^{′}}}{{GPA}_{t}} ) ;$$

where t represents the number of the preset time period, t=1, 2, . . . , T, T represents the total number of preset time periods, GPAₜ′ represents the optimized gyroscope data accuracy evaluation index of the t-th preset time period, GDAₜ represents the gyroscope data accuracy evaluation index of the t-th preset time period, ZMₜ represents the zero-bias mean of the t-th preset time period, AVₜ represents the angular velocity variance of the t-th preset time period, NVₜ represents the noise variance of the t-th preset time period, VCₜ represents the vector consistency error of the t-th preset time period, TIₜ represents the time integration error of the t-th preset time period, SEₜ represents the sensitivity error of the t-th preset time period, α represents the collection weight, β represents the processing weight, GPAₜ represents the gyroscope processing accuracy evaluation index of the -th preset time period, and e represents the natural constant.

Further, the specific process of determining whether to perform data preprocessing optimization according to the gyroscope processing accuracy evaluation index is as follows: comparing the processing adjustment threshold obtained from the preset database with the gyroscope processing accuracy evaluation index. If the gyroscope processing accuracy evaluation index is not less than the processing adjustment threshold obtained from the preset database, data preprocessing optimization is not performed. If the gyroscope processing accuracy evaluation index is less than the processing adjustment threshold obtained from the preset database, data preprocessing optimization is performed. Data preprocessing optimization means performing data smoothing processing and feedback iteration on the gyroscope data.

Further, the specific process of obtaining the dynamic mapping accuracy index is as follows: performing dynamic data mapping based on the gyroscope processing data. The dynamic data mapping means mapping the motion patterns to keyboard key events. The motion patterns include shaking, tilting, and rotating. After performing dynamic data mapping, obtaining the reference feedback data and the mapping analysis weights from the preset database. The reference feedback data includes the motion recognition accuracy rate threshold, the missed recognition rate threshold, the false recognition rate threshold, the motion recognition delay threshold, the instruction conversion delay threshold, and the false triggering rate threshold. The mapping analysis weights include the processing optimization weight and the dynamic mapping weight. Comparing the motion feedback data with the reference feedback data to obtain the compliance number, and obtaining the motion feedback coefficients according to the motion feedback data and the reference feedback data. The motion feedback coefficients include the motion recognition accuracy rate coefficient, the missed recognition rate coefficient, the false recognition rate coefficient, the motion recognition delay coefficient, the instruction conversion delay coefficient, and the false triggering rate coefficient. The dynamic mapping accuracy index is obtained by comprehensively analyzing the motion feedback data, the reference feedback data, the mapping analysis weights, and the compliance number.

Further, the specific process of determining whether to perform mapping optimization is as follows: obtaining the mapping optimization threshold from the preset database and comparing the obtained mapping optimization threshold with the obtained dynamic mapping accuracy index. If the dynamic mapping accuracy index is not less than the mapping optimization threshold obtained from the preset database, mapping optimization is not performed. If the dynamic mapping accuracy index is less than the mapping optimization threshold obtained from the preset database, mapping optimization is performed. Performing mapping optimization means dynamically adjusting the action trigger thresholds corresponding to the keyboard key events according to the preset ratio. The action trigger thresholds include the X-axis threshold and the Y-axis threshold.

In the embodiments of the present application, the one or more technical solutions provided have at least the following technical effects or advantages:

By using the gyroscope data accuracy evaluation index to determine whether to perform data preprocessing, if data preprocessing is performed, obtaining the gyroscope processing accuracy evaluation index based on the gyroscope processing data after data preprocessing and the gyroscope data accuracy evaluation index to determine whether to perform data preprocessing optimization, then performing dynamic data mapping based on the gyroscope processing data, and combining the acquired motion feedback data with the gyroscope processing accuracy evaluation index to obtain the dynamic mapping accuracy index to determine whether to perform mapping optimization, the universality of smart wearable devices is enhanced, and the accuracy of gyroscope data conversion is improved, effectively solving the problem of inaccurate gyroscope data conversion during user motion recognition through smart wearable devices in the prior art.

By numbering the preset time periods and obtaining the reference gyroscope data from the preset database, obtaining the angular velocity accuracy coefficient according to the angular velocities of the three axes of the gyroscope and the expected angular velocity values, then performing data preprocessing on the zero-bias drift, the noise density, the response rate, and the temperature drift rate, and then processing the results after data preprocessing in combination with the angular velocity accuracy coefficient and the corresponding reference gyroscope data to obtain the gyroscope data accuracy evaluation index, the accuracy of data collection is evaluated more accurately, and corresponding measures can be taken to improve the accuracy of data collection.

By substituting the gyroscope data after data preprocessing into the specific limit expression of the gyroscope data accuracy evaluation index to obtain the optimized gyroscope data accuracy evaluation index, normalizing the gyroscope processing data, and obtaining the gyroscope processing accuracy evaluation index based on the gyroscope data accuracy evaluation index, the optimized gyroscope data accuracy evaluation index, and the normalized gyroscope processing data, the accuracy of the gyroscope data after data preprocessing is evaluated more accurately, and corresponding measures can be taken in time to improve the accuracy of data preprocessing.

### DESCRIPTION OF DRAWINGS

To illustrate the technical solutions of the embodiments of the present disclosure more clearly, the following briefly introduces the accompanying drawings that need to be used in the embodiments. It should be understood that the following drawings only show some embodiments of the present disclosure and therefore should not be regarded as limiting the scope. For those of ordinary skill in the art, other relevant drawings can be obtained according to these drawings without creative efforts.

### DESCRIPTION OF EMBODIMENTS

The embodiments of the present application solve the problem of inaccurate gyroscope data conversion during user motion recognition through smart wearable devices in the prior art by providing a gyroscope data conversion method for smart wearable devices. By numbering the preset time periods and obtaining the reference gyroscope data from the preset database, obtaining the angular velocity accuracy coefficient according to the angular velocities of the three axes of the gyroscope and the expected angular velocity values, then performing data preprocessing on the zero-bias drift, the noise density, the response rate, and the temperature drift rate, and then processing the results after data preprocessing in combination with the angular velocity accuracy coefficient and the corresponding reference gyroscope data to obtain the gyroscope data accuracy evaluation index and determine whether to perform data preprocessing. If data preprocessing is performed, substituting the gyroscope data after data preprocessing into the specific limit expression of the gyroscope data accuracy evaluation index to obtain the optimized gyroscope data accuracy evaluation index, normalizing the gyroscope processing data, and obtaining the gyroscope processing accuracy evaluation index based on the gyroscope data accuracy evaluation index, the optimized gyroscope data accuracy evaluation index, and the normalized gyroscope processing data and determine whether to perform data preprocessing optimization. Finally, performing dynamic data mapping based on the gyroscope processing data and combining the acquired motion feedback data with the gyroscope processing accuracy evaluation index to obtain the dynamic mapping accuracy index to determine whether to perform mapping optimization, the accuracy of gyroscope data conversion is improved.

The technical solution of the embodiments of the present application to solve the above problem of inaccurate gyroscope data conversion during user motion recognition through smart wearable devices is as follows:

By obtaining the gyroscope data accuracy evaluation index from the acquired gyroscope data and determining whether to perform data preprocessing accordingly. If data preprocessing is performed, obtaining the gyroscope processing accuracy evaluation index based on the gyroscope processing data after data preprocessing and the gyroscope data accuracy evaluation index and determining whether to perform data preprocessing optimization. Then, performing dynamic data mapping based on the gyroscope processing data and combining the acquired motion feedback data with the gyroscope processing accuracy evaluation index to obtain the dynamic mapping accuracy index to determine whether to perform mapping optimization, the effect of improving the accuracy of gyroscope data conversion is achieved.

For a better understanding of the above technical solution, the following will describe the above technical solution in detail with reference to the drawings and specific embodiments.

It is a flowchart of a gyroscope data conversion method for smart wearable devices provided by the embodiments of the present application. The method includes the following steps: obtaining a gyroscope data accuracy evaluation index from the gyroscope data acquired in a preset time period and determining whether to perform data preprocessing according to the gyroscope data accuracy evaluation index. The gyroscope data accuracy evaluation index is used to quantify the accuracy of the gyroscope data. If data preprocessing is performed, a gyroscope processing accuracy evaluation index is obtained based on the gyroscope processing data after data preprocessing and the gyroscope data accuracy evaluation index and determining whether to perform data preprocessing optimization. The gyroscope processing accuracy evaluation index is used to quantify the accuracy of the gyroscope data after data preprocessing. Dynamic data mapping is performed based on the gyroscope processing data and a dynamic mapping accuracy index is obtained by combining the acquired motion feedback data with the gyroscope processing accuracy evaluation index and determining whether to perform mapping optimization. The dynamic mapping accuracy index is used to judge the accuracy of the dynamic data mapping.

In this embodiment, through the gyroscope data accuracy evaluation index and the subsequent processing accuracy evaluation index, the accuracy of the gyroscope data can be quantified and improved to ensure the data quality and provide a reliable basis for subsequent applications. At the same time, according to the judgment of the evaluation index, the data processing and mapping processes can be dynamically optimized to improve the accuracy of the gyroscope data conversion.

It should be noted that the gyroscope data includes the angular velocities of the three axes of the gyroscope, a timestamp, a sampling frequency, a zero-bias drift, a noise density, a response rate, and a temperature drift rate. The angular velocities of the three axes of the gyroscope include the angular velocity of the X-axis, the angular velocity of the Y-axis, and the angular velocity of the Z-axis. The angular velocities of the three axes of the gyroscope and the response rate are the mean values of the corresponding data in the preset time period. The gyroscope processing data includes the zero-bias mean, the angular velocity variance, the noise variance, the vector consistency error, the time integration error, and the sensitivity error. The motion feedback data includes the motion recognition accuracy rate, the missed recognition rate, the false recognition rate, the motion recognition delay, the instruction conversion delay, and the false triggering rate.

The angular velocities of the three axes of the gyroscope are directly obtained by the gyroscope sensor. The timestamp and sampling frequency are obtained from the device log. The zero-bias drift is calculated from the output value of the gyroscope in the stationary state. The noise density is calculated by collecting the angular velocity data output by the gyroscope and calculating the standard deviation of the output in the preset time period. The response rate is obtained by measuring the time delay between the input signal and the output signal of the gyroscope. The temperature drift rate is calculated by recording the angular velocity deviation at different temperatures. The gyroscope processing data is obtained by performing mean, variance, vector length, time integration, and error operations on the gyroscope data. The motion recognition accuracy rate is calculated by comparing the recognition result with the real result. The missed recognition rate represents the proportion of the number of unrecognized motions to the total number of motions. The false recognition rate represents the proportion of the number of misclassified motions to the total number of motions. The motion recognition delay is obtained by measuring the time difference from the occurrence of the motion to the recognition of the motion by the system. The instruction conversion delay is measured by the time difference from the recognition of the motion by the system to the execution of the corresponding instruction. The false triggering rate is measured by the proportion of the number of times the system falsely triggers an instruction to the total number of triggered instructions. Through the acquisition of the above data, a data basis is laid for subsequent data analysis.

Further, the specific process of obtaining the gyroscope data accuracy evaluation index is as follows: numbering the preset time periods and obtaining reference gyroscope data from a preset database. The reference gyroscope data includes the expected angular velocity values, the set timestamp, and the set sampling frequency. The expected angular velocity values include the expected angular velocity of the X-axis, the expected angular velocity of the Y-axis, and the expected angular velocity of the Z-axis. The angular velocity accuracy coefficient is obtained according to the angular velocities of the three axes of the gyroscope and the expected angular velocity values. The angular velocity accuracy coefficient is used to quantify the accuracy of the angular velocity of the gyroscope in the smart wearable device. Data preprocessing is performed on the zero-bias drift, the noise density, the response rate, and the temperature drift [symbol] . The data preprocessing is used to remove the units and unify the dimensions of the data. The gyroscope data accuracy evaluation index is obtained by processing the results after data preprocessing in combination with the angular velocity accuracy coefficient and the corresponding reference gyroscope data.

The specific limit expression of the gyroscope data accuracy evaluation index is as follows:

$${GDA}_{t} = \frac{\begin{matrix}{AAC}_{t} + {cot}^{- 1} ( \frac{\vert {TS}_{t} - {TS}_{0} \vert}{{TS}_{0}} ) + {cot}^{- 1} ( \frac{\vert {SF}_{t} - {SF}_{0} \vert}{S {F}_{0}} ) + \\ sech ( \frac{Z {B}_{t} + {ND}_{t} + {TD}_{t}}{3} ) + tanh ( R {R}_{t} )\end{matrix}}{5} \\ {AAC}_{t} = exp [ - ( \frac{\vert {AX}_{t} - A {X}_{0} \vert}{{AX}_{0}} + \frac{\vert A {Y}_{t} - A {Y}_{0} \vert}{A {Y}_{0}} + \frac{\vert {AZ}_{t} - A {Z}_{0} \vert}{A {Z}_{0}} ) ]$$

where t represents the number of the preset time period, t=1, 2, . . . , T, T represents the total number of preset time periods, AACₜ represents the angular velocity accuracy coefficient of the t-th preset time period, TSₜ represents the timestamp of the t-th preset time period, SF represents the sampling frequency of the t-th preset time period, ZBₜ represents the zero-bias drift of the t-th preset time period, NDₜ represents the noise density of the t-th preset time period, TDₜ represents the response rate of the t-th preset time period, RRₜ represents the temperature drift rate of the t-th preset time period, AXₜ represents the X-axis angular velocity of the t-th preset time period, AYₜ represents the Y-axis angular velocity of the t-th preset time period, AZₜ represents the Z-axis angular velocity of the t-th preset time period, TS₀ represents the set timestamp, SF, represents the set sampling frequency, AX₀ represents the expected X-axis angular velocity, AY₀ represents the expected Y-axis angular velocity, AZ₀ represents the expected Z-axis angular velocity, GDAₜ represents the gyroscope data accuracy evaluation index of the t-th preset time period.

In this embodiment, the algorithm comprehensively analyzes the angular velocity accuracy coefficient, the timestamp, the sampling frequency, the zero-bias drift, the noise density, the response rate, the temperature drift rate, and the reference gyroscope data to obtain the gyroscope data accuracy evaluation index. In the formula, as the angular velocity accuracy coefficient increases, the corresponding gyroscope data accuracy evaluation index also increases. When the differences between the timestamp and the sampling frequency and the corresponding set timestamp and set sampling frequency are smaller, the corresponding gyroscope data accuracy evaluation index is larger. As the zero-bias drift, the noise density, and the response rate increase, the corresponding gyroscope data accuracy evaluation index decreases. However, as the temperature drift rate increases, the corresponding gyroscope data accuracy evaluation index also increases. When the gyroscope data accuracy evaluation index is larger, it indicates that the corresponding collected gyroscope data is more accurate. By analyzing the gyroscope data accuracy evaluation index, it is helpful to take corresponding measures in time to improve the availability of the data.

Specifically, assuming that the expected X-axis angular velocity, the expected Y-axis angular velocity, and the expected Z-axis angular velocity are all 100 rad/s, it is a schematic diagram of the change of the angular velocity accuracy coefficient with the X-axis angular velocity provided by the embodiments of the present application. When the Y-axis angular velocity and the Z-axis angular velocity are both 100 rad/s, as the X-axis angular velocity approaches the expected X-axis angular velocity, the graph shows an upward trend, and the corresponding angular velocity accuracy coefficient increases.

It is a schematic diagram of the change of the angular velocity accuracy coefficient with the Y-axis angular velocity provided by the embodiments of the present application. When the X-axis angular velocity and the Z-axis angular velocity are both 100 rad/s, as the Y-axis angular velocity approaches the expected Y-axis angular velocity, the graph shows an upward trend, and the corresponding angular velocity accuracy coefficient increases.

It is a schematic diagram of the change of the angular velocity accuracy coefficient with the Z-axis angular velocity provided by the embodiments of the present application. When the X-axis angular velocity and the Y-axis angular velocity are both 100 rad/s, as the Z-axis angular velocity approaches the expected Z-axis angular velocity, the graph shows an upward trend, and the corresponding angular velocity accuracy coefficient increases.

Through the above analysis, the relationship between the X-axis angular velocity, the Y-axis angular velocity, the Z-axis angular velocity, and the angular velocity accuracy coefficient is more intuitively shown. By analyzing the angular velocity accuracy coefficient, it is helpful to better understand the change of the angular velocity and adjust and improve the accuracy of the angular velocity-related data in time.

Specifically, the parameters involved in the processing of the gyroscope data accuracy evaluation index in this algorithm are interrelated and do not exist independently. The three-axis angular velocity data is sampled in time series. The timestamp reflects the time point corresponding to each group of angular velocity data. If the sampling frequency is too low, the three-axis angular velocity data may lose important information (such as details of the motion). If the timestamp is inaccurate or the sampling frequency is unstable, the time interval deviation between the data will occur, affecting the accuracy of the motion trajectory calculation. The zero-bias drift will cause a systematic error in the angular velocity measurement and accumulate into an angle error during the integration process. The temperature drift makes the performance of the gyroscope inconsistent at different environmental temperatures and requires temperature compensation. When the noise density is high, a filtering algorithm (such as low-pass filtering or Kalman filtering) needs to be used to reduce the influence of noise on the angular velocity measurement. If the response rate is insufficient, the angular velocity signal will lag, affecting the real-time calculation of the motion trajectory. The combined action of noise and temperature drift may lead to error accumulation and affect the stability of the long-term measurement results.

Specifically, the reference gyroscope data is obtained from a preset database. In a specific embodiment, the reference gyroscope data is set by professional smart wearable device test staff according to specific test conditions.

Further, the specific process of determining whether to perform data preprocessing according to the gyroscope data accuracy evaluation index is as follows: obtaining the collection adjustment threshold from the preset database and comparing it with the gyroscope data accuracy evaluation index. If the gyroscope data accuracy evaluation index is not less than the collection adjustment threshold obtained from the preset database, data preprocessing is performed. If the gyroscope data accuracy evaluation index is less than the collection adjustment threshold obtained from the preset database, the collection frequency is increased according to the preset adjustment ratio and the standby wireless network is switched to.

In this embodiment, by comparing the gyroscope data accuracy evaluation index with the collection adjustment threshold, the situation of insufficient data accuracy can be found in time, and corresponding measures (such as increasing the collection frequency and switching the network) can be taken to improve the data quality.

Specifically, the collection adjustment threshold is obtained from the preset database. In a specific embodiment, the gyroscope data that causes inaccurate user motion recognition due to data collection in the historical data is substituted into the specific limit expression of the gyroscope data accuracy evaluation index to obtain the corresponding data set, and the mean value of the data set is calculated to obtain the collection adjustment threshold.

Further, the specific steps of performing data preprocessing are as follows: Step 1, performing time series synchronization on the gyroscope data and performing interpolation processing according to the preset sampling rate. The interpolation processing is used to ensure the integrity of the gyroscope data. Step 2, performing noise removal processing on the gyroscope data through a low-pass filtering program. The noise removal processing is used to eliminate the random fluctuations from equipment vibration, electromagnetic interference, and the measurement environment. Step 3, performing standardization processing on the gyroscope data. The standardization processing means that the gyroscope data conforms to the change trend of a standard normal distribution with a mean of 0 and a standard deviation of 1.

In this step, the time series synchronization aims to align the data collected at different times to ensure that they are in chronological order. The interpolation processing fills in the missing data points between different time points to make the data more continuous and smooth. For example, if there is a time interval between two consecutive data points where no data was collected, interpolation can be used to estimate the value at that interval based on the values of adjacent data points. The low-pass filtering program filters out high-frequency noise components, which helps to improve the signal-to-noise ratio of the data. Common low-pass filtering algorithms include Butterworth filtering, Chebyshev filtering, etc. The standardization processing normalizes the data to a specific distribution range, making different data more comparable and facilitating subsequent processing. It is usually calculated by subtracting the mean value of the data from each data point and then dividing by the standard deviation.

The specific implementation of the low-pass filtering program can be represented by the following formula:

$${X}_{standardized} = \frac{x - μ}{σ}$$

where x represents the original data, u represents the mean of the original data, σ represents the standard deviation of the original data, and X_{standardized} represents the standardized data.

After the data preprocessing is completed, the gyroscope processing accuracy evaluation index is calculated. Initially, the gyroscope data after preprocessing is substituted into the specific limit expression of the gyroscope data accuracy evaluation index to obtain the optimized gyroscope data accuracy evaluation index. Subsequently, the gyroscope processing data is normalized. The normalization process guarantees that the gyroscope optimized data is in the same dimension. Finally, the gyroscope processing accuracy evaluation index is computed based on the gyroscope data accuracy evaluation index, the optimized gyroscope data accuracy evaluation index, and the normalized gyroscope processing data. The specific formula for calculating the gyroscope processing accuracy evaluation index is:

$${GPA}_{t} = [ {( \frac{e - 1}{e + 1} )}^{ln ( {ZM}_{t} + A {V}_{t} + N {V}_{t} + V {C}_{t} + T {I}_{t} + S {E}_{t} + 1 )} + 1 ] * cosh ( \frac{{GPA}_{{t}^{′}}}{{GPA}_{t}} )$$

where t represents the number of the preset time period (t=1, 2, . . . , T), T represents the total number of preset time periods, GPAₜ′ represents the optimized gyroscope data accuracy evaluation index of the t-th preset time period, GDAₜ represents the gyroscope data accuracy evaluation index of the t-th preset time period, ZMₜ represents the zero-bias mean of the t-th preset time period, AVₜ represents the angular velocity variance of the t-th preset time period, NVₜ represents the noise variance of the t-th preset time period, VCₜ represents the vector consistency error of the t-th preset time period, TIₜ represents the time integration error of the t-th preset time period, SEₜ represents the sensitivity error of the t-th preset time period, a represents the collection weight, β represents the processing weight, and GPAₜ represents the gyroscope processing accuracy evaluation index of the t-th e preset time period.

Next, the gyroscope processing accuracy evaluation index is compared with the processing adjustment threshold obtained from the preset database. If the gyroscope processing accuracy evaluation index is not less than the processing adjustment threshold, no data preprocessing optimization is required. Otherwise, data preprocessing optimization is carried out. Data preprocessing optimization involves performing data smoothing processing and feedback iteration on the gyroscope data. Data smoothing can be achieved through methods such as moving average or median filtering to highlight the change trend of the gyroscope data. Feedback iteration is utilized to balance the types of gyroscope data and supplement the original gyroscope data.

After that, dynamic data mapping is performed based on the gyroscope processing data. The dynamic data mapping maps the motion patterns (including shaking, tilting, and rotating) to keyboard key events. For example, when the X-axis angular velocity exceeds a certain threshold, the “right arrow” key is triggered; when the X-axis angular velocity is less than the negative of the threshold, the “left arrow” key is triggered. Similarly, for the Y-axis, when the angular velocity exceeds the threshold, the “up arrow” key is triggered, and when it is less than the negative of the threshold, the “down arrow” key is triggered.

Following the dynamic data mapping, the reference feedback data and the mapping analysis weights are retrieved from the preset database. The reference feedback data includes the motion recognition accuracy rate threshold, the missed recognition rate threshold, the false recognition rate threshold, the motion recognition delay threshold, the instruction conversion delay threshold, and the false triggering rate threshold. The mapping analysis weights comprise the processing optimization weight and the dynamic mapping weight.

The motion feedback data is then compared with the reference feedback data to obtain the compliance number. Based on the motion feedback data and the reference feedback data, the motion feedback coefficients are calculated. The motion feedback coefficients include the motion recognition accuracy rate coefficient, the missed recognition rate coefficient, the false recognition rate coefficient, the motion recognition delay coefficient, the instruction conversion delay coefficient, and the false triggering rate coefficient.

Finally, the dynamic mapping accuracy index is obtained by comprehensively analyzing the motion feedback data, the reference feedback data, the mapping analysis weights, and the compliance number. The specific formula for calculating the dynamic mapping accuracy index is:

$${DMA}_{t} = θ * {GPA}_{t} + γ * {sinh}^{- 1} [ \sqrt{\frac{{AFC}_{t}^{1} + {AFC}_{t}^{2} + {AFC}_{t}^{3} + {AFC}_{t}^{4} + {AFC}_{t}^{5} + {AFC}_{t}^{6}}{6}} * cosh ( M {Q}_{t} ) ] ; \\ {AFC}_{t}^{1} = tanh [ max ( A {R}_{t} - A {R}_{0} , 0 ) ] \\ {AFC}_{t}^{2} = sech [ max ( L {R}_{t} - L {R}_{0} , 0 ) ] \\ {AFC}_{t}^{3} = sech [ max ( M {R}_{t} - {MR}_{0} , 0 ) ] \\ {AFC}_{t}^{4} = sech [ max ( {CD}_{t} - {CD}_{0} , 0 ) ] \\ {AFC}_{t}^{5} = sech [ max ( {IC}_{t} - {IC}_{0} , 0 ) ] \\ {AFC}_{t}^{6} = sech [ max ( E {T}_{t} - E {T}_{0} , 0 ) ]$$

where t represents the number of the preset time period (t=1, 2, . . . , T), T represents the total number of preset time periods, where GPAₜ represents the dynamic mapping accuracy index of the t-th preset time period, and are the mapping analysis weights, ARₜ represents the motion recognition accuracy rate of the t-th preset time period, LRₜ represents the motion recognition accuracy rate threshold, MRₜ represents the false recognition rate of the t-th preset time period, CDₜ represents the false recognition rate threshold, ICₜ represents the motion recognition delay of the -th preset time period, ETₜ represents the motion recognition delay threshold,

$${AFC}_{t}^{1}$$

represents the instruction conversion delay of the t-th preset time period,

$${AFC}_{t}^{2}$$

represents the instruction conversion delay threshold,

$${AFC}_{t}^{3}$$

represents the false triggering rate of the t-th preset time period, and

$${AFC}_{t}^{4}$$

represents the false triggering rate threshold.

This dynamic mapping accuracy index is then compared with the mapping optimization threshold obtained from the preset database. If the dynamic mapping accuracy index is not less than the mapping optimization threshold, no mapping optimization is performed. If the dynamic mapping accuracy index is less than the mapping optimization threshold, mapping optimization is carried out. Mapping optimization involves dynamically adjusting the action trigger thresholds corresponding to the keyboard key events according to the preset ratio. For instance, if the dynamic mapping accuracy index shows that the mapping from the motion pattern of “shaking” to the “Enter” key is not accurate enough, the action trigger thresholds for the X-axis and Y-axis angular velocities related to the “shaking” motion can be adjusted to enhance the mapping accuracy.

In this specific implementation, the following steps contribute to the overall performance and accuracy improvement of the gyroscope data conversion method for smart wearable devices:

The process of obtaining the gyroscope data accuracy evaluation index enables a quantitative assessment of the initial gyroscope data quality, allowing for timely decisions on whether data preprocessing is necessary. By comparing the acquired data with the reference data from the database and considering various factors, a comprehensive evaluation index is obtained.

The data preprocessing steps, including time series synchronization, interpolation, noise removal, and standardization, enhance the quality and integrity of the gyroscope data. The interpolation processing fills in the data gaps, noise removal mitigates the impact of external interference, and standardization normalizes the data distribution, facilitating subsequent processing and analysis.

The gyroscope processing accuracy evaluation index further assesses the quality of the preprocessed data, taking into account not only the preprocessed data itself but also its relationship with the original data accuracy evaluation index, providing a more comprehensive evaluation of the data after preprocessing.

Data preprocessing optimization ensures continuous improvement of data quality by performing smoothing and feedback iteration when necessary, reducing noise and improving the stability of the data.

Dynamic data mapping converts motion patterns into keyboard key events, making the device's motion information useful for user interaction. By comparing the actual motion feedback data with reference data and using various coefficients and weights, the accuracy of the mapping can be evaluated and optimized.

The dynamic mapping accuracy index and mapping optimization mechanism ensure that the mapping relationship between motion patterns and keyboard key events is continuously refined, enhancing the user's interaction experience with the smart wearable device.

By following these steps, the present application provides a robust and adaptable gyroscope data conversion method for smart wearable devices, effectively addressing the issues of data accuracy and conversion efficiency, and thereby improving the overall performance and user experience of such devices.

It should be noted that, during the implementation, appropriate adjustments may be made based on the specific performance and requirements of different smart wearable devices. Additionally, the selection of parameters such as thresholds and weights in the formulas can be calibrated through experiments and tests to achieve the best performance for different application scenarios. For example, for a sports monitoring smartwatch, the thresholds and weights might be adjusted differently compared to a virtual reality headset, depending on the typical motion patterns and user interaction requirements of the respective devices.

Moreover, different types of low-pass filters can be employed depending on the characteristics of the noise in the gyroscope data. For example, if the noise has a relatively low frequency component, a Butterworth filter with a lower order might be sufficient, while for more complex noise spectra, a higher-order Chebyshev filter could be considered.

The method presented herein provides a flexible framework that can be customized and optimized to accommodate different gyroscope models, sampling frequencies, and user motion patterns, thereby maximizing the utility of gyroscope data in smart wearable devices.

Furthermore, the data processing and analysis steps described above can be implemented in software, firmware, or a combination of both. In a software implementation, the algorithms can be coded in a programming language such as Java, C++, or Python. For example, the interpolation function can be implemented as a method within a Java class. The low-pass filtering program can be designed as a separate module that takes the gyroscope data as input and returns the filtered data. The standardization process can be integrated into a data preprocessing pipeline.

In a firmware implementation, the algorithms can be embedded directly into the microcontroller of the smart wearable device. This allows for real-time processing of the gyroscope data without relying on an external host device. The firmware can be designed to optimize the memory usage and processing speed, ensuring efficient operation even with limited resources.

To ensure the reliability and accuracy of the method, extensive testing and validation are required. This includes collecting a large amount of gyroscope data under different conditions, such as various user motions, environmental temperatures, and electromagnetic interference levels. The data can be divided into training and testing sets. The training set is used to optimize the parameters of the algorithms, such as the thresholds and weights. The testing set is then used to evaluate the performance of the method.

During the testing process, metrics such as the motion recognition accuracy rate, missed recognition rate, false recognition rate, motion recognition delay, instruction conversion delay, and false triggering rate are calculated and compared with the predefined thresholds. If the performance does not meet the requirements, further adjustments to the algorithms or parameters are made.

In addition, the method can be integrated with other sensors and algorithms in the smart wearable device. For example, it can work in conjunction with an accelerometer to provide more comprehensive motion information. The data from the gyroscope and accelerometer can be fused using sensor fusion algorithms to improve the accuracy of motion recognition.

Moreover, the method can be updated and refined over time. As new data is collected and analyzed, the algorithms can be improved to adapt to new user behaviors and device characteristics. This can be achieved through over-the-air (OTA) updates, allowing users to receive the latest version of the software or firmware without having to replace the device.

Finally, it is important to document the implementation details and performance results of the method. This includes creating detailed technical reports, user manuals, and patent documentation. The documentation should clearly describe the steps of the method, the parameters used, and the performance metrics achieved. This helps to ensure the reproducibility and usability of the method and provides valuable information for future research and development.

In conclusion, the specific implementation of the gyroscope data conversion method for smart wearable devices presented in this application involves a series of steps from data acquisition to processing and optimization. By following these steps and continuously improving the method through testing and updates, the accuracy and reliability of gyroscope data conversion can be effectively enhanced, providing a better user experience and more accurate motion recognition capabilities for smart wearable devices.

1. A gyroscope data conversion method for smart wearable devices, comprising the following steps:
obtaining a gyroscope data accuracy evaluation index from the gyroscope data acquired in a preset time period, and determining whether to perform data preprocessing according to the gyroscope data accuracy evaluation index, wherein the gyroscope data accuracy evaluation index is used to quantify the accuracy of the gyroscope data;
if data preprocessing is performed, obtaining a gyroscope processing accuracy evaluation index based on the gyroscope processing data after data preprocessing and the gyroscope data accuracy evaluation index, and determining whether to perform data preprocessing optimization according to the gyroscope processing accuracy evaluation index, wherein the gyroscope processing accuracy evaluation index is used to quantify the accuracy of the gyroscope data after data preprocessing;
performing dynamic data mapping based on the gyroscope processing data, and obtaining a dynamic mapping accuracy index by combining the acquired motion feedback data with the gyroscope processing accuracy evaluation index, and determining whether to perform mapping optimization according to the dynamic mapping accuracy index, wherein the dynamic mapping accuracy index is used to judge the accuracy of the dynamic data mapping.

2. The gyroscope data conversion method of claim 1, wherein the gyroscope data includes the angular velocities of the three axes of the gyroscope, a timestamp, a sampling frequency, a zero-bias drift, a noise density, a response rate, and a temperature drift rate, and the angular velocities of the three axes of the gyroscope include the angular velocity of the X-axis, the angular velocity of the Y-axis, and the angular velocity of the Z-axis, and the angular velocities of the three axes of the gyroscope and the response rate are the mean values of the corresponding data in the preset time period, and the gyroscope processing data includes the zero-bias mean, the angular velocity variance, the noise variance, the vector consistency error, the time integration error, and the sensitivity error, and the motion feedback data includes the motion recognition accuracy rate, the missed recognition rate, the false recognition rate, the motion recognition delay, the instruction conversion delay, and the false triggering rate.

3. The gyroscope data conversion method of claim 1, wherein the specific process of obtaining the gyroscope data accuracy evaluation index comprises:
numbering the preset time periods and obtaining reference gyroscope data from a preset database, wherein the reference gyroscope data includes the expected angular velocity values, the set timestamp, and the set sampling frequency, and the expected angular velocity values include the expected angular velocity of the X-axis, the expected angular velocity of the Y-axis, and the expected angular velocity of the Z-axis;
obtaining the angular velocity accuracy coefficient according to the angular velocities of the three axes of the gyroscope and the expected angular velocity values, wherein the angular velocity accuracy coefficient is used to quantify the accuracy of the angular velocity of the gyroscope in the smart wearable device;
performing data preprocessing on the zero-bias drift, the noise density, the response rate, and the temperature drift rate, wherein the data preprocessing is used to remove the units and unify the dimensions of the data;
obtaining the gyroscope data accuracy evaluation index by processing the results after data preprocessing in combination with the angular velocity accuracy coefficient and the corresponding reference gyroscope data.

4. The gyroscope data conversion method of claim 1, wherein the specific process of determining whether to perform data preprocessing according to the gyroscope data accuracy evaluation index comprises:
obtaining the collection adjustment threshold from the preset database and comparing it with the gyroscope data accuracy evaluation index;
if the gyroscope data accuracy evaluation index is not less than the collection adjustment threshold obtained from the preset database, performing data preprocessing;
if the gyroscope data accuracy evaluation index is less than the collection adjustment threshold obtained from the preset database, increasing the collection frequency according to the preset adjustment ratio and switching the standby wireless network.

5. The gyroscope data conversion method of claim 1, wherein the specific steps of performing data preprocessing comprise:
step 1: performing time series synchronization on the gyroscope data and performing interpolation processing according to the preset sampling rate, wherein the interpolation processing is used to ensure the integrity of the gyroscope data;
step 2: performing noise removal processing on the gyroscope data through a low-pass filtering program, wherein the noise removal processing is used to eliminate the random fluctuations from equipment vibration, electromagnetic interference, and the measurement environment;
step 3: performing standardization processing on the gyroscope data, wherein the standardization processing means that the gyroscope data conforms to the change trend of a standard normal distribution with a mean of 0 and a standard deviation of 1.

6. The gyroscope data conversion method of claim 1, wherein the specific process of obtaining the gyroscope processing accuracy evaluation index comprises:
substituting the gyroscope data after data preprocessing into the specific limit expression of the gyroscope data accuracy evaluation index to obtain the optimized gyroscope data accuracy evaluation index;
normalizing the gyroscope processing data, wherein the normalization processing is used to ensure that the gyroscope optimized data is in the same dimension;
obtaining the gyroscope processing accuracy evaluation index based on the gyroscope data accuracy evaluation index, the optimized gyroscope data accuracy evaluation index, and the normalized gyroscope processing data.

7. The gyroscope data conversion method of claim 1, wherein the specific method of obtaining the gyroscope processing accuracy evaluation index is expressed by the following formula:
$${GPA}_{t} = [ {( \frac{e - 1}{e + 1} )}^{ln ( {ZM}_{t} + A {V}_{t} + N {V}_{t} + V {C}_{t} + T {I}_{t} + S {E}_{t} + 1 )} + 1 ] * cosh ( \frac{{GPA}_{{t}^{′}}}{{GPA}_{t}} )$$
where t represents the number of the preset time period, t=1, 2, . . . , T, T represents the total number of preset time periods, GPAₜ′ represents the optimized gyroscope data accuracy evaluation index of the t-th preset time period, GDAₜ represents the gyroscope data accuracy evaluation index of the t-th preset time period, ZMₜ represents the zero-bias mean of the t-th preset time period, AVₜ represents the angular velocity variance of the t-th preset time period, NVₜ represents the noise variance of the t-th preset time period, VCₜ represents the vector consistency error of the t-th preset time period, TIₜ represents the time integration error of the t-th preset time period, SEₜ represents the sensitivity error of the t-th preset time period, α represents the collection weight, β represents the processing weight, GPAₜ represents the gyroscope processing accuracy evaluation index of the -th preset time period, and e represents the natural constant.

8. The gyroscope data conversion method of claim 1, wherein the specific process of determining whether to perform data preprocessing optimization according to the gyroscope processing accuracy evaluation index comprises:
comparing the processing adjustment threshold obtained from the preset database with the gyroscope processing accuracy evaluation index;
if the gyroscope processing accuracy evaluation index is not less than the processing adjustment threshold obtained from the preset database, not performing data preprocessing optimization;
if the gyroscope processing accuracy evaluation index is less than the processing adjustment threshold obtained from the preset database, performing data preprocessing optimization, wherein data preprocessing optimization means performing data smoothing processing and feedback iteration on the gyroscope data.

9. The gyroscope data conversion method of claim 1, wherein the specific process of obtaining the dynamic mapping accuracy index comprises:
performing dynamic data mapping based on the gyroscope processing data, wherein the dynamic data mapping means mapping the motion patterns to keyboard key events, and the motion patterns include shaking, tilting, and rotating;
after performing dynamic data mapping, obtaining the reference feedback data and the mapping analysis weights from the preset database, wherein the reference feedback data includes the motion recognition accuracy rate threshold, the missed recognition rate threshold, the false recognition rate threshold, the motion recognition delay threshold, the instruction conversion delay threshold, and the false triggering rate threshold, and the mapping analysis weights include the processing optimization weight and the dynamic mapping weight;
comparing the motion feedback data with the reference feedback data to obtain the compliance number, and obtaining the motion feedback coefficients according to the motion feedback data and the reference feedback data, wherein the motion feedback coefficients include the motion recognition accuracy rate coefficient, the missed recognition rate coefficient, the false recognition rate coefficient, the motion recognition delay coefficient, the instruction conversion delay coefficient, and the false triggering rate coefficient;
obtaining the dynamic mapping accuracy index by comprehensively analyzing the motion feedback data, the reference feedback data, the mapping analysis weights, and the compliance number.

10. The gyroscope data conversion method of claim 1, wherein the specific process of determining whether to perform mapping optimization comprises:
obtaining the mapping optimization threshold from the preset database and comparing the obtained mapping optimization threshold with the obtained dynamic mapping accuracy index;
if the dynamic mapping accuracy index is not less than the mapping optimization threshold obtained from the preset database, not performing mapping optimization;
if the dynamic mapping accuracy index is less than the mapping optimization threshold obtained from the preset database, performing mapping optimization, wherein performing mapping optimization means dynamically adjusting the action trigger thresholds corresponding to the keyboard key events according to the preset ratio, and the action trigger thresholds include the X-axis threshold and the Y-axis threshold.
